(19) United States
(12) Patent Application Publication
(10) Pub. No.: US 2008/0159502 A1
(43) Pub. Date: Jul. 3, 2008

(54) Method and Apparatus For Providing Caller Identification Information

(75) Inventors: Prema Venkatesulu, Yardley, PA (US); Louis D. Bifano, Morrisville, PA (US); Thomas F. Kister, Chalfont, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/617,215

(22) Filed: Dec. 28, 2006

(51) Int. Cl. H04M 1/56

(52) U.S. Cl. 379/142.06

(57) ABSTRACT

In one embodiment, a method and apparatus for providing caller identification information is disclosed. One or more valid alternate phone numbers is configured using a remote interface. The one or more valid alternate phone numbers are then stored.

In another embodiment, a method and apparatus for providing caller identification information is disclosed. One or more valid alternate phone numbers is configured using a local interface. The one or more valid alternate phone numbers are then stored.

In another embodiment, a method and apparatus for providing caller identification information is disclosed. A phone number is selected from a plurality of valid phone numbers comprising a primary phone number and one or more alternate phone numbers. The selected phone number is sent when placing a call.

### FIELD OF THE INVENTION

This invention relates generally to managing calls in a communication network, and more particularly, to a method and system for providing caller identification information.

### BACKGROUND OF THE INVENTION

In accordance with existing techniques, a docking system can be used to establish a communication link between communication devices. The docking system enables transmission and synchronization of data between the connected communication devices. Use of a docking system allows a user to make calls with accessory handsets using the network of the mobile telephone in the docking system. When an accessory handset makes a call, the caller ID number of the mobile telephone is sent for display on the called device. A user may want to use an accessory handset (for ease of use) but wishes to avail of the call rates applicable to the mobile telephone. For example, the cost of long-distance calls from a mobile telephone may be a lower cost alternative due to the contract plans of mobile telephone service providers. In this docking system, a cellular telephone can be used to make calls, but the calls can be managed by using connected wired telephone systems.

In view of the foregoing details, there exists a need for a method and system that can provide flexibility to a user to configure and send alternate caller identification information.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary system, in accordance with an embodiment of the present invention;

FIG. 2 illustrates a block diagram of a docking system, in accordance with an embodiment of the present invention;

FIG. 3 illustrates a block diagram of an accessory handset, in accordance with one embodiment of the present invention;

FIG. 4 is a flow diagram illustrating a method for providing caller identification information, in accordance with an embodiment of the present invention;

FIG. 5 is a flow diagram illustrating a method for providing caller identification information, in accordance with an embodiment of the present invention; and

FIG. 6 is a flow diagram illustrating a method for providing caller identification information, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of embodiments of the present invention.

### DETAILED DESCRIPTION

Before describing in detail the particular method and system for managing calls from a docking system, in accordance with various embodiments of the present invention, it should be observed that the present invention resides primarily in combinations of method steps and apparatus components related to the method and system for managing calls from the docking system. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, relational terms such as first and second, and the like, may be used solely to distinguish one entity or action from another entity or action, without necessarily requiring or implying any actual relationship or order between such entities or actions. The terms “comprises,” “comprising”, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

In one embodiment, a method, apparatus, and computer readable medium for providing caller identification information is disclosed. One or more valid alternate phone numbers is configured using a remote interface. The one or more valid alternate phone numbers are then stored.

In another embodiment, a method, apparatus, and computer readable medium for providing caller identification information is disclosed. One or more valid alternate phone numbers is configured using a local interface. The one or more valid alternate phone numbers are then stored.

In another embodiment, a method, apparatus, and computer readable medium for providing caller identification information is disclosed. A phone number is selected from a plurality of valid phone numbers comprising a primary phone number and one or more alternate phone numbers. The selected phone number is sent when placing a call.

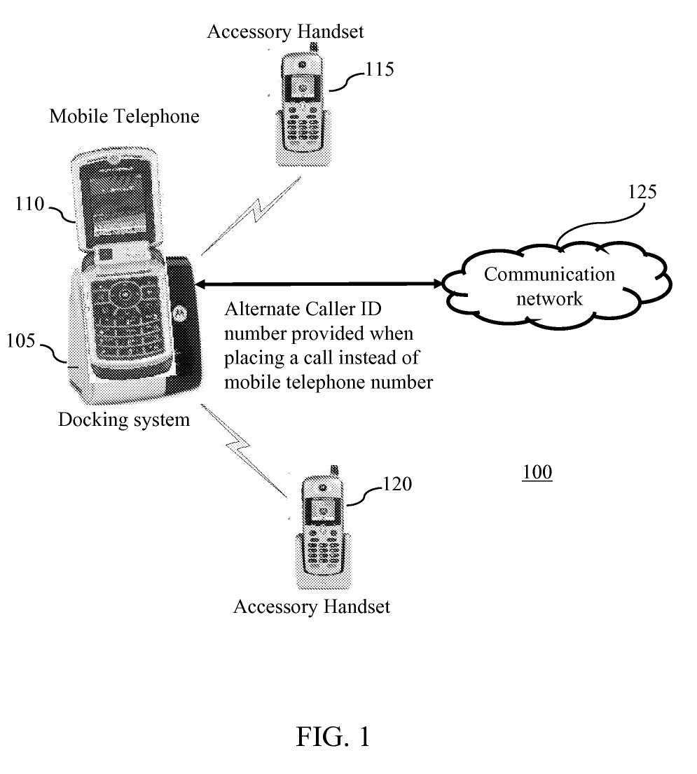

FIG. 1 illustrates an exemplary system 100, in accordance with an embodiment of the present invention. The system 100 comprises a docking system 105, a mobile phone 110 and accessory handsets 115, 120. When mobile telephone 110 is docked at docking station 105, accessory handsets 115 may be used to make calls using the communication network 125 of mobile telephone 110. In one embodiment, one or more valid alternate telephone numbers is configured. In another embodiment, when a call is placed using an accessory handset either the mobile telephone number or one of valid telephone numbers is provided as caller identification information. A valid telephone number for a user comprises a telephone number that is associated with the user. Although only the docking system 105, mobile telephone 110, and accessory handsets 115, 120 have been shown in FIG. 1, it will be apparent to a person ordinarily skilled in the art that the communication network 100 can include more electronic devices and docking systems. The connection between the accessory handset 115, 120 and the docking system 105 may be a wired or wireless connection.

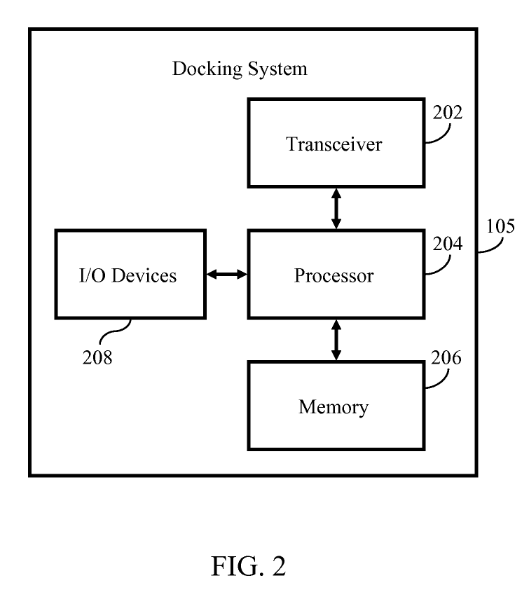

FIG. 2 illustrates a block diagram of the docking system 105, in accordance with an embodiment of the present invention. The docking system 105 includes a transceiver 202, a processor 204, memory 206, and input/output devices 208 (e.g., storage devices, including but not limited to, a tape drive, a floppy drive, a hard disk drive or a compact disk drive, a speaker, a display, an image capturing sensor, e.g., those used in a digital still camera or digital video camera, a clock, an output port, a user input device (such as a keyboard, a keypad, a mouse, and the like, or a microphone for capturing speech commands). The docking system 105 supports placing a call via a communication network 125 of mobile telephone 110 using accessory handset 115, 120.

In one embodiment, a local interface 208 is used to configure one or more valid alternate telephone numbers. The valid alternate telephone numbers may be stored in memory 206. The valid alternate telephone numbers may also be stored in the accessory handset 115, 120.

In another embodiment local interface 208 is used to select a phone number from a plurality of valid phone numbers comprising a primary phone number and one or more alternate phone numbers. When a call is placed, the selected phone number is sent as caller identification information. In one embodiment, the selected phone number is chosen using a local interface 208. In another embodiment, the selected phone number is chosen from a list of the plurality of valid phone numbers using the local interface.

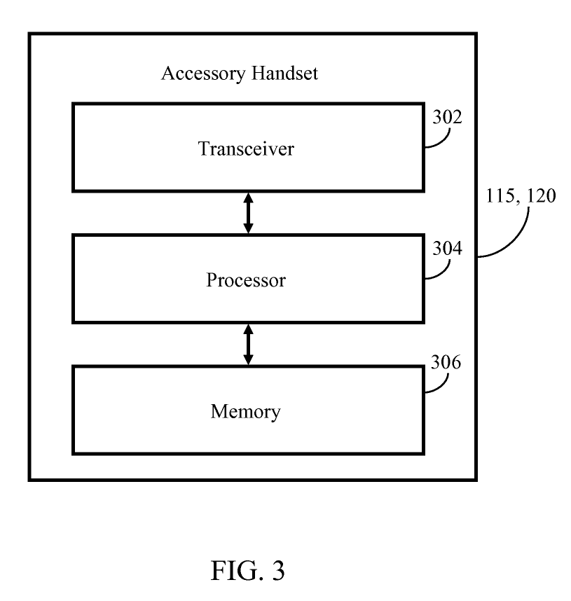

FIG. 3 illustrates a block diagram of the accessory handset 115, 120, in accordance with an embodiment of the present invention. The accessory handset 115, 120 includes a transceiver 302, a processor 304, and memory 306. The accessory handset 115, 120 may place a call via a communication network 125 of mobile telephone 110 using docking system 105.

In one embodiment, a remote interface, e.g., accessory handset 115, 120 is used to configure one or more valid alternate telephone numbers. The valid alternate telephone numbers may be stored in memory 306. The valid alternate telephone numbers may also be stored in docking system 105.

In another embodiment the remote interface is used to select a phone number from a plurality of valid phone numbers comprising a primary phone number and one or more alternate phone numbers. When a call is placed, the selected phone number is sent as caller identification information. In one embodiment, the selected phone number is chosen using a local interface 208. In another embodiment, the selected phone number is chosen from a list of the plurality of valid phone numbers using the remote interface.

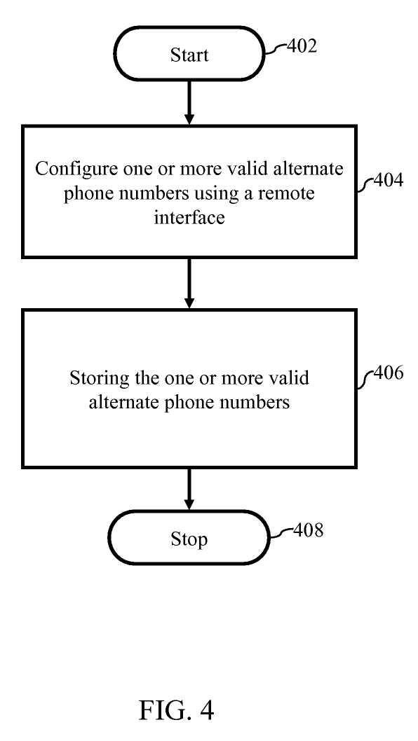

FIG. 4 is a flow diagram illustrating a method for managing calls from a docking system, in accordance with an embodiment of the present invention. The method given above details the different steps involved in managing calls from a docking system. Further, the method can comprise greater number of steps than that shown in FIG. 4. To describe the flow diagram, reference will be made to FIG. 1, FIG. 2, and FIG. 3, although it will be understood by a person ordinarily skilled in the art that the flow diagram can be implemented with reference to any other suitable embodiment of the present invention.

The method is initiated at step 402. At step 404, one or more valid alternate phone numbers is configured using a remote interface. In one embodiment, the remote interface comprises an accessory handset 115, 120.

At step 406, the one or more valid alternate phone numbers is stored. In one embodiment, the one or more valid alternate phone numbers is stored at the remote interface 115, 120. In another embodiment, the one or more alternate phone numbers is stored at docking system 105.

In an embodiment, the method can be implemented in a computer-readable storage element with a computer-readable code stored thereon, to program a computer to perform the method. Thereafter, the method terminates at step 408.

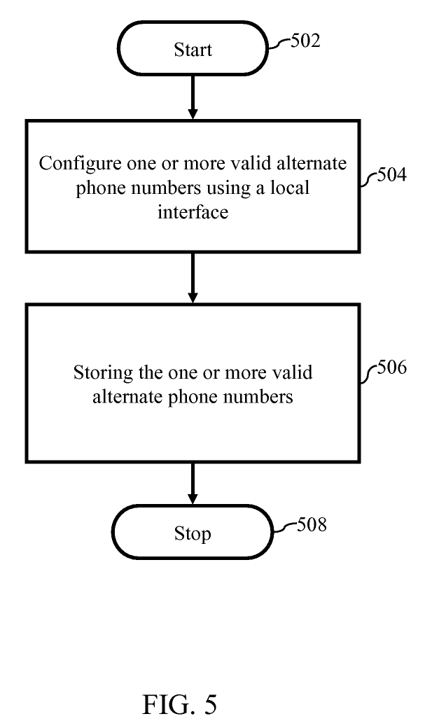

FIG. 5 is a flow diagram illustrating a method for managing calls from a docking system, in accordance with an embodiment of the present invention. The method given above details the different steps involved in managing calls from a docking system. Further, the method can comprise greater number of steps than that shown in FIG. 5. To describe the flow diagram, reference will be made to FIG. 1, FIG. 2, and FIG. 3, although it will be understood by a person ordinarily skilled in the art that the flow diagram can be implemented with reference to any other suitable embodiment of the present invention.

The method is initiated at step 502. At step 404, one or more valid alternate phone numbers is configured using a local interface. In one embodiment, the local interface comprises docking system 105.

At step 506, the one or more valid alternate phone numbers is stored. In one embodiment, the one or more valid alternate phone numbers is stored at the remote interface 115, 120. In another embodiment, the one or more alternate phone numbers is stored at docking system 105.

In an embodiment, the method can be implemented in a computer-readable storage element with a computer-readable code stored thereon, to program a computer to perform the method. Thereafter, the method terminates at step 508.

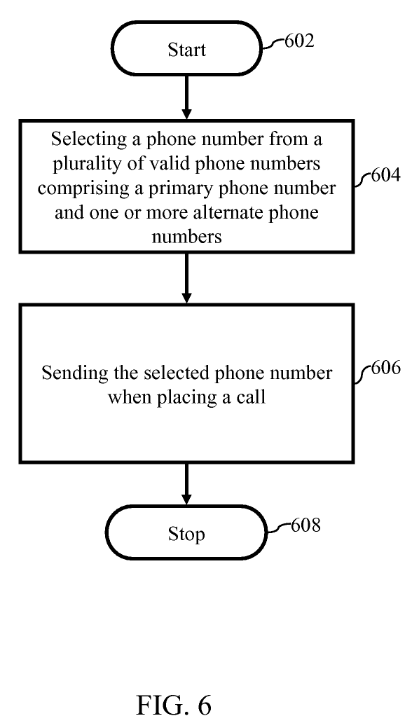

FIG. 6 is a flow diagram illustrating a method for managing calls from a docking system, in accordance with another embodiment of the present invention. The method shows the different steps involved in managing calls from a docking system. Moreover, the method can comprise a greater number of steps than that shown in FIG. 6. To describe the flow diagram, reference will be made to FIG. 1, FIG. 2, and FIG. 3, although it will be understood by a person ordinarily skilled in the art that the flow diagram can be implemented with reference to any other suitable embodiment of the present invention.

The method is initiated at step 602. At step 604, a phone number to send as caller identification information is selected from a plurality of valid phone numbers comprising a primary phone number and one or more alternate telephone numbers. The primary phone number may comprise a mobile telephone number of a user. An example of an alternate telephone number may be a home telephone number of a user. The plurality of valid phone numbers may be stored in memory 206 or memory 306. The phone number to send as caller identification information may be selected at a local interface, e.g. docking system 105. The phone number to send as caller identification information may also be selected from a list of valid telephone numbers using either a remote interface at accessory handset 115, 120 or a local interface at docking system 105.

At step 606, the selected phone number is sent as caller identification information when a call is placed. In one embodiment, the method can be implemented in a computer-readable storage element with a computer-readable code stored thereon, to program a computer to perform the method. Thereafter, the method terminates at step 608.

Various embodiments, as described above, provide a method and system for managing calls through a docking system. A user of a mobile telephone can send the caller identification of the local telephone communication system to other electronic devices in the telephone network by using a docking system. This is useful when the user wants to place a call using the mobile telephone network but wishes to receive calls on the local telephone communication system because of the cheaper call-rate plan offered by the local telephone communication system. Further, sending the local telephone communication system number enables the user to communicate through the local telephone communication system in the event of the battery of the mobile telephone getting discharged or while encountering problems pertaining to a weak signal reception on the mobile telephone.

A user may also find it useful to send a home number as an alternate caller identification number in the event of an emergency. If there is an emergency and the user makes an emergency call to a 911 service, since the user's home number is sent as caller identification information instead of the mobile telephone number, the 911 operator is able to quickly and accurately identify the location of the caller.

It will be appreciated that the method and system for managing calls from the docking system described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. Therefore, these functions may be interpreted as steps of a method that enables users to view a broadcasted media stream differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, the available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for providing caller identification information, comprising:
configuring one or more valid alternate phone numbers using a remote interface;
storing the one or more valid alternate phone numbers.

2. The method of claim 1, wherein the one or more valid alternate phone numbers is stored at the remote interface.

3. The method of claim 1, wherein the one or more valid alternate phone numbers is stored at a docking system.

4. The method of claim 1, wherein the remote interface comprises an accessory handset.

5. A method for providing caller identification information, comprising:
configuring one or more valid alternate phone numbers using a local interface;
storing the one or more valid alternate phone numbers.

6. The method of claim 5, wherein the one or more valid alternate phone numbers is stored at an accessory handset.

7. The method of claim 5, wherein the one or more valid alternate phone numbers is stored at the local interface.

8. The method of claim 5, wherein the local interface comprises a docking system.

9. A method for providing caller identification information, comprising:
selecting a phone number from a plurality of valid phone numbers comprising a primary phone number and one or more alternate phone numbers;
sending the selected phone number when placing a call.

10. The method of claim 9, wherein selecting the phone number comprises selecting the phone number from a list of the plurality of valid phone numbers using an interface.

11. The method of claim 10, wherein the interface comprises a local interface.

12. The method of claim 10, wherein the interface comprises a remote interface.

13. The method of claim 9, wherein selecting the phone number comprises selecting the phone number using a local interface.

14. An apparatus for providing caller identification information, comprising:
an interface for configuring one or more valid alternate phone numbers;
storage means for storing the one or more valid alternate phone numbers.

15. The apparatus of claim 14, wherein the interface comprises a local interface.

16. The apparatus of claim 15, wherein the storage means resides at the local interface.

17. The apparatus of claim 15, wherein the storage means resides at a remote interface.

18. The apparatus of claim 14, wherein the interface comprises a remote interface.

19. The apparatus of claim 18, wherein the storage means resides at a local interface.

20. The apparatus of claim 18, wherein the storage means resides at the remote interface.

21. An apparatus for providing caller identification information, comprising:
an interface for selecting a phone number from a plurality of valid phone numbers comprising a primary phone number and one or more alternate phone numbers;
means for sending the selected phone number when placing a call.

22. The apparatus of claim 21, wherein the interface comprises an accessory handset and the means for sending comprises a docking system for sending the selected phone number when placing the call.
